(19) United States
(12) Patent Application Publication
(10) Pub. No.: US 2005/0190424 A1
(43) Pub. Date: Sep. 1, 2005

(54) Method and device for optical scanning of objects

(75) Inventors: Juergen Reichenbach, Emmendingen (DE); Roland Gehring, Elzach (DE); Daniel Schumacher, Teningen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sick AG, Waldkirch (DE)

(21) Appl. No.: 11/069,183

(22) Filed: Feb. 28, 2005

(30) Foreign Application Priority Data
Feb. 27, 2004 (DE) 10 2004 009 496.9

(51) Int. Cl. G02B 26/08

(52) U.S. Cl. 359/216; 359/204

(57) ABSTRACT

A method and an apparatus for the optically scanning of objects, especially markings, use at least two emitters (10; 20) arranged so that light beams (12; 22) emitted by them sample or scan the object at different angles. The at least two emitters (10, 20) are arranged so that the emitted light beams (12, 24) strike reflecting surfaces (32) of a polygonal mirror (30) at different angles to a plane (36) that is perpendicular to an axis of rotation of the polygonal mirror, and which direct the beams onto the object being scanned so that the beams strike the object at different angles. The polygonal mirror (30) directs the beams reflected by the object onto an associated, separate receiver system to form at least two separate emitter/receiver channels.

### BACKGROUND OF THE INVENTION

The invention relates to the optical scanning of objects, especially markings, with light beams from at least two separate emitter/receiver channels and a rotating polygonal light beam deflecting mirror.

A device of this kind is known from EP 0 480 348 A1, where light beams from two emitters, such as lasers, are directed via a partially reflecting and transmitting mirror in a common beam direction and impinge on a rotating polygonal mirror, which directs the light beams onto an object to be scanned, for example a barcode. The light reflected by the object is again directed via the polygonal mirror to a common receiver system. The two emitters have different focal lengths, so that they can scan objects at varying distances from the device. The emitters are first alternatingly operated to determine which focal length corresponds to the distance of the object being scanned. Thereafter, only one of the emitters is operated and used to scan the object. Thus, the use of two emitters with different focal lengths increases the depth of focus of the device.

Another device which uses two pairs of emitters of the kind described in EP 0 480 348 A1 is known from U.S. Pat. No. 6,527,184 B1. The light beams of the two emitter pairs travel in different planes which are set off from each other in the direction of the axis of rotation of the polygonal mirror. This is supposed to compensate for the parallax that may occur when different distances are involved.

EP 0 444 958 B1 discloses a device for scanning barcodes in which the light beams from two emitters, after deflection by a polygonal mirror, impinge on a group of neighboring mirrors having different inclinations. These mirrors are oriented so that the different light beams strike the barcode being scanned at different angles, which permits an omnidirectional scanning of the barcodes.

### SUMMARY OF THE INVENTION

In view thereof, it is an object of the present invention to provide a method and a simple apparatus of the kind mentioned above, which can be used for reliably optically scanning objects that have no defined position relative to the device.

An important aspect of the present invention is the scanning of an object with a rotating polygonal mirror and at least two light beams from emitter/receiver channels that are separated from each other. The emitters are arranged so that the light beams emitted by them sweep over the object in scanning planes which strike the object at different angles. If a noisy or otherwise unusable signal is generated due to an unfavorable position of the object relative to the scanning plane of a particular channel, for example as a result of superimposed reflections when the light beam is perpendicular onto the coating of a barcode, then the signal from the other channel can be used.

The device of the present invention has at least two independent emitter/receiver channels and a common rotating polygonal mirror assigned to both channels, which directs the light beams from the emitters onto the object being scanned. The emitters are arranged so that they are inclined at different angles relative to a plane that is perpendicular to the axis of rotation of the polygonal mirror. As a result, the light beams from the different emitters strike the mirror or reflecting surfaces of the polygonal mirror at different angles. The reflected beams are then directed onto the object, which they sweep in differently inclined scanning planes. The light beams are reflected by the object and are directed to the particular receiver. In this fashion, the object is separately scanned with the different emitter/receiver channels, and the scanning planes formed by the different light beams strike the object at different inclinations without requiring additional mirror arrangements to vary the angle of inclination.

If one emitter lies above (or to one side) and another below (or to the other side), the plane perpendicular to the axis of rotation of the polygonal mirror, and both emitters have an angular inclination of the same magnitude relative to this plane, these positive and negative angles are considered to be different for purposes of the present invention.

For purposes of this application, “light” means any electromagnetic radiation, especially radiation in the wavelength range from ultraviolet to infrared. The structural elements of the device, such as its mirrors, are to be adapted to the wavelengths or wavelength ranges used.

The separate emitter/receiver channels allow the method and apparatus of the present invention to be flexibly adapted to particular requirements of a given installation.

In one advantageous embodiment of the invention, the at least two emitters are positioned so that at least one emitter is above (or to one side of) a plane that is perpendicular to the axis of rotation of the polygonal mirror and intersects it, and at least one emitter is below (or to the other side of) this plane. The emitters are each oriented so that their beams strike the polygonal mirror as close as possible to that plane. In this manner, the polygonal mirror and the overall device can have a relatively flat shape.

In a preferred embodiment, the emitters are further arranged so that the beams emitted by at least one emitter pair, which has one emitter above and the other below the plane that is perpendicular to the axis of rotation of and intersects the polygonal mirror, strike the polygonal mirror at angles of the same magnitude relative to that plane. If more than two emitter/receiver channels, and especially when more than one emitter pair are provided, this angle of the same magnitude preferably has a different value for each emitter pair to provide additional scanning angles for scanning the object.

In another embodiment of the invention, at least two emitters are arranged so that their light beams strike the polygonal mirror with an angular offset relative to each other in the direction of rotation of the polygonal mirror, so that the individual emitter/receiver channels scan the object with a phase shift. For example, when using two emitters for both emitter/receiver channels and the signals are noise-free and usable, twice the scanning frequency is obtained as compared to an identical arrangement but without such a phase shift. In a preferred embodiment, the emitters are arranged at angles with the same magnitude relative to the plane containing the axis of rotation of the polygonal mirror, which is characterized by external considerations, such as an exit opening in a housing, with half of the total number of emitters lying on the left side and the other half on the right of this plane. If at least four instead of two emitters are used, set off in pairs relative to each other in the direction of rotation of the polygonal mirror, and they have different inclinations of their respective planes that include the axis of rotation of the polygonal mirror as compared to the plane that is perpendicular to the axis of rotation of the polygonal mirror, a comprehensive doubling of the scanning frequency is attained. In the event of an unusable signal in one channel, the signal of the corresponding second emitter is available, whose light beam strikes the object at a different angle.

In another advantageous embodiment, more than two emitter/receiver channels, e.g. four channels, are arranged so that each pair of emitters is situated in a plane containing the axis of rotation of the polygonal mirror. The planes of the different emitter pairs are angularly offset relative to each other in the direction of rotation of the polygonal mirror. Furthermore, the emitters of a particular emitter pair are arranged in one of these planes at different angles to a plane perpendicular to the axis of rotation of the polygonal mirror. In this manner, the light beams cross as they are projected onto the object being scanned, which enables an omnidirectional scanning of the object. If only two correspondingly arranged emitters are used, an omnidirectional scanning is only possible if both emitters generate usable signals and one of them is not defective, for example due to noise from superimposed reflections. If at least four emitters are used in the manner described, then an especially preferred embodiment of the invention arranges the two emitters in a plane containing the axis of rotation of the polygonal mirror symmetrically relative to the plane that is perpendicular to the axis of rotation of the polygonal mirror and also arranges the emitter pair in a plane that is set off in the direction of rotation of the polygonal mirror. This provides an x-shaped scanning pattern, or a so-called x-scan pattern, that is projected onto the object being scanned.

In a further embodiment of the invention, the light of the emitter is focused on the associated receiver. The individual receivers are arranged in the same place as the corresponding emitters and are provided with a hole, in which the emitter is located. As an alternative, the reflected light beams are separated with a tilted, partially reflecting mirror arranged in the beam path between the emitter and the polygonal mirror, which directs the reflected light beam towards the associated receiver. The focusing of the individual emitter/receiver channels is done manually or, in a preferred embodiment, at least partly by autocollimation.

Another embodiment provides different focusing for the at least two separate emitter/receiver channels, which can be used to distinguish the reflected signals from the different channels.

In yet another embodiment of the invention, at least one omnidirectional receiver is provided for at least partially detecting the light reflected by an object. The separation of the signals from the different channels is accomplished by giving the individual emitter/receiver channels different modulation frequencies and/or different wavelengths and/or different signal encodings or conditionings, and the receivers are adapted to them or the at least two emitter/receiver channels employ different code recognition methods. Furthermore, the use of emitter/receiver channels with different wavelengths is also advantageous for scanning different objects having maximum contrast at different wavelengths. This enables a reliable scanning without having to first adapt the device to the altered characteristics of the objects.

Laser diodes, which are preferably used as light sources for the emitters, often have a noncircular, typically rectangular, emitting surface. This produces an astigmatism during focusing, i.e. a different focal length in the plane of the longer axis and the plane of the shorter axis of the laser diode. An advantageous embodiment of the invention makes use of this fact when two emitter/receiver channels are used by arranging the laser diodes at roughly 90° relative to each other. The astigmatism is thereby exploited to increase the focal depth range of the device, or to produce elliptical focus spots. Elliptical focus forms are advantageous when the objects being scanned are oblong and have a defined orientation relative to the device. In such cases, the elliptical light spot is oriented with its longer axis parallel to the longer dimension of the object, e.g. the lines of a barcode, thereby achieving a stronger contrast for the scanning. As an alternative or in addition thereto, in another embodiment the same effect is achieved by using shaping diaphragms in front of the emitters.

According to the invention, noise in the scanning results due to reflections caused by layers superimposed on the object being scanned, such as films on barcodes, is avoided due to the use of at least two light beams, which strike the object at different scanning angles. In addition, in one form of the invention, polarized light is used to distinguish between directional reflection and diffuse scattered light. When using only two separate emitter/receiver channels, in a preferred embodiment complementary polarized light is used to separate the signals. The light source of one emitter/receiver channel is provided with a polarizer, which is complementary to that used with the light source of the other channel (left- and right-circular polarized light or linear polarized light perpendicular to each other). The receiver of each channel includes an analyzer which only permits the passage of light of the same polarization as the corresponding emitter.

In a preferred embodiment of the invention, the individual emitter/receiver channels are each focused at a different distance from the device and/or focused in part by autocollimation. For all channels taken together, the device has a greater focal depth.

Furthermore, in an advantageous variation, the emitter/receiver channels are arranged in such a way that they are set off from each other to enable a three-dimensional evaluation of the scanning signals. The emitters have defined spatial distances from each other, so that information about the position of the object in space and its surface shape can be obtained from the reflected light components of the different channels.

The invention is not limited to the embodiments described above. It can also be operated dynamically with electronic or software-based controls in an especially preferred embodiment, so that advantageous combinations or sequences of configurations can be achieved. For example, the outcome of an initial scan with at least one emitter/receiver channel can be used to optimize the parameters for subsequent scans with at least one other emitter/receiver channel or to adapt the signal processing in the receiver to the encountered conditions. In this way, among other things, an electromechanical fine focusing based on previous scans is possible. Moreover, alternating scans of the object can be achieved with at least two emitter/receiver channels.

### BRIEF DESCRIPTION OF THE DRAWINGS

FIG. 1 schematically illustrates the basic principle of the invention;

FIG. 2 is a side view of the invention;

FIG. 3 schematically shows an emitter displaced in the direction of rotation of a rotating polygonal mirror; and

FIG. 4 shows an x-scan pattern.

### DESCRIPTION OF THE PREFERRED EMBODIMENTS

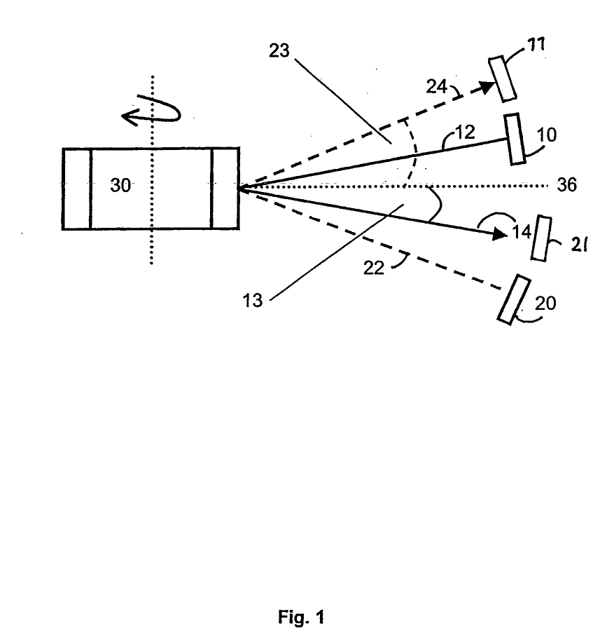

FIG. 1 schematically shows the basic principle of the invention with two separate emitter/receiver channels. Two emitters 10 and 20 comprising a light source, e.g. a laser, and an optical focusing system are arranged at different angles to a plane which is perpendicular to the axis of rotation of a polygonal mirror 30. Light beams 12 and 22 of emitters 10 and 20 strike the rotating polygonal mirror 30. Beams 14 and 24 reflected by a mirror or reflective surface of the polygonal mirror leave at different angles of inclination relative to a plane that is perpendicular to the axis of rotation of polygonal mirror 30, the so-called skew angles 13 and 23. Reflected beams 14 and 24 sweep over an object that is being scanned as the polygonal mirror 30 rotates and are reflected by the latter and directed towards receiver systems (11, 21), which are configured in a familiar manner and include an optoelectronic transducer as well a signal processor or processing component.

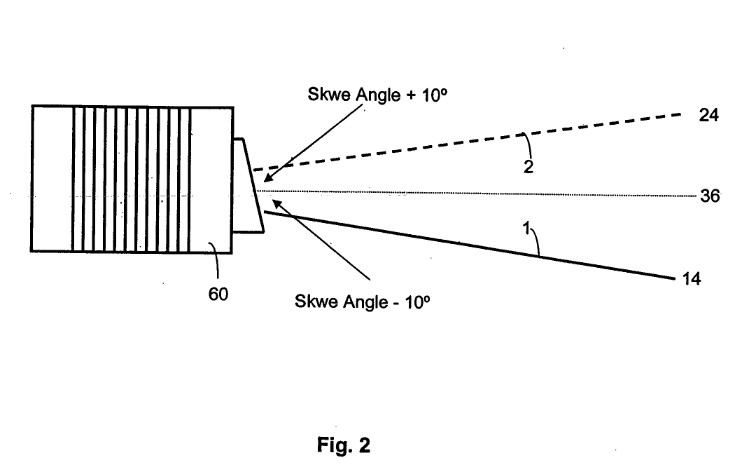

FIG. 2 shows a side view of a scanner 60 of the present invention. Two separate emitter/receiver systems are arranged so that scanning beams 14 and 24 leave the scanner 60 at different skew angles of, for example, −10° and +10° relative to a plane 36 that is perpendicular to the axis of rotation of polygonal mirror 30. Due to the rotation of polygonal mirror 30 in the scanner 60, beams 14 and 24 sweep over the object in fan fashion in scanning planes 1 and 2 and scan it at different angles of incidence relative to the surface normals of the object. If desired, the skew angles can of course vary.

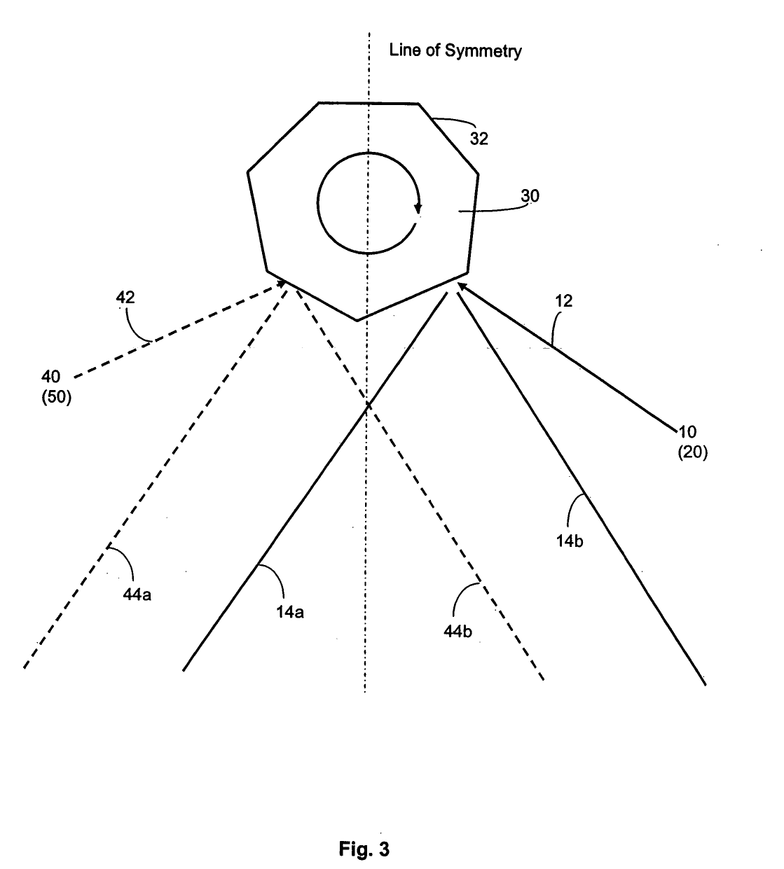

FIG. 3 shows two emitter pairs 10, 20 and 40, 50 which are set off relative to each other in the direction of rotation of polygonal mirror 30. Emitters 10, 20 and 40, 50, respectively, are arranged in a common plane that contains the axis of rotation of the polygonal mirror. In the top view of FIG. 3, therefore, only the upper emitters 10, 40 of each respective pair is shown. The emitter 10 emits light beam 12 onto the rotating polygonal mirror 30. It is reflected by mirror surfaces 32, and as the polygonal mirror 30 turns, it sweeps over the object being scanned in a fan-like manner, is reflected by the object and then is directed into a receiver system (not shown in FIG. 3). For each mirror surface 32, the light beam sweeps a fan-shaped area, defined by maximum and minimum deflection directions 14a and 14b. Similarly, a light beam 42 originating from emitter 40 is deflected by the polygonal mirror 30 and sweeps a fan-shaped scanning region, which again is defined by minimum and maximum light beam deflections 44a and 44b. Accordingly, the light beams of the second emitters 20 and 50 of the two emitter pairs sweep the object in synchronization at different skew angles. With this arrangement, the object is scanned with phase offset by the light beams 14 and 44, and the corresponding light beams from emitters 20 and 50, to achieve a doubling of the scanning frequency relative to a system with only one pair of emitter/receiver channels. There is no disruption from superimposed reflections since, if necessary, the signal of the second emitter of a given emitter pair can be used, which is arranged at a different skew angle and can furnish a usable signal.

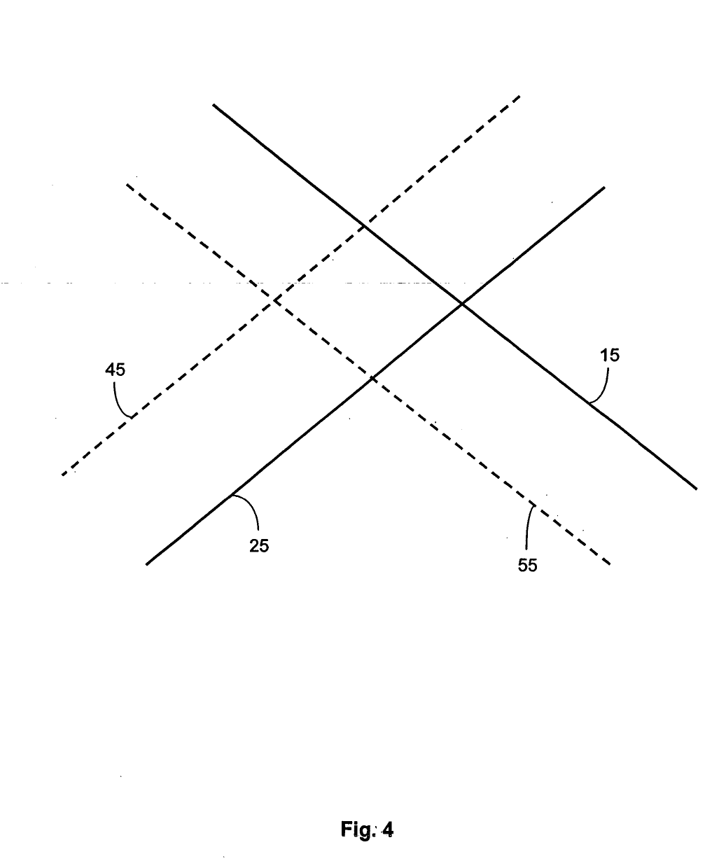

If all emitters in FIG. 3 are arranged at a skew angle of the same magnitude, by giving the skew angles of the beams from emitters 20 and 50 the opposite, e.g. positive, sign from that, e.g. negative, sign of the skew angles of the beams from the corresponding emitters 10 and 40, a crossed scanning pattern (also known as x-scan pattern) is obtained in the projection onto the object being scanned, as is shown in FIG. 4. In FIG. 4, reference numerals 15, 25, 45 and 55 show the projection of the respective light beams from emitters 10, 20, 40 and 50 sweeping over the object being scanned. The x-scan pattern enables a reliable omnidirectional scanning of objects, since crossing scan lines are present for different skew angles. In general, of course, crossed scan patterns can also be obtained with appropriate different skew angles for the individual emitters.

The separation of the receiving systems for the different emitters 10, 20, etc. can be accomplished in a variety of ways. Besides a mechanical-structural separation by varied focusing of the different emitter/receiver channels, in which the focusing can be done by means of familiar autocollimation systems, it is also possible to modulate the emitters differently and undertake a signal separation with appropriately adapted receiving systems. Furthermore, the emitters can be provided with light sources of different wavelengths, in particular, different laser wavelengths, and the corresponding receivers are tuned to them. Moreover, electronic signal encoding methods are possible in combination with an appropriate receiver adaptation. If only two emitters are used, a channel separation is also possible by having the two emitters emit light polarized perpendicular to each other and outfitting the receivers with corresponding polarization filters.

Of course, the invention is not limited to the use of two or four emitter/receiver channels. The emitter arrangements presented in the drawings can easily be changed to a larger number of emitters, for example, in order to cover a larger number of different skew angles or provide a greater focal depth range. A laser configuration can also be repeatedly arranged along the axis of rotation of a polygonal mirror in a device so that several objects can be simultaneously scanned at different locations.

1. A method for optically scanning objects comprising scanning the object with light beams from at least two emitter/receiver channels, directing the light beams onto a rotating polygonal mirror, and reflecting the light beams with the polygonal mirror at different skew angles.

2. A method according to claim 1 including operating the at least two emitter/receiver channels with different focuses.

3. A method according to claim 1 including operating the at least two emitter/receiver channels with light of differing polarization.

4. A method according to claim 1 wherein the at least two emitter/receiver channels have emitters and associated receivers, and including operating the emitters at different modulation frequencies, and tuning the receivers to the different modulation frequencies.

5. A method according to claim 1 wherein the at least two emitter/receiver channels have emitters and associated receivers, and including operating the emitters so they emit light of different wavelengths, and tuning the receivers to the different wavelengths.

6. A method according to claim 1 wherein the at least two emitter/receiver channels employ different electronic signal encoding or signal conditioning.

7. A method according to claim 1 including using signals from at least one of the receiver systems for tracking parameters of at least one other emitter/receiver channel.

8. A method according to claim 1 wherein the at least two emitter/receiver channels alternatingly scan the object.

9. An apparatus for optically scanning objects comprising at least two separate emitter/receiver channels each including an emitter, and a rotating polygonal mirror which directs light beams emitted by emitters onto the object being scanned, directions of the light beams from the emitters being inclined at different angles relative to a plane that is perpendicular to an axis of rotation of the polygonal mirror.

10. An apparatus according to claim 9 wherein the light beam directions are set off from each other in a rotational direction of the polygonal mirror.

11. An apparatus according to claim 10 wherein the light beam directions define angles of identical magnitude relative to a designated plane which includes the axis of rotation of the polygonal mirror, one emitter being arranged on one side of the designated plane and another one of the emitters being arranged on the other side of the designated plane.

12. An apparatus according to claim 9 wherein at least one of the emitters is arranged above and at least one of the emitters is arranged below the plane that is perpendicular to the axis of rotation of the polygonal mirror.

13. An apparatus according to claim 9 wherein the beams are arranged in pairs and the beam directions have an angular inclination of identical magnitude relative to the plane that is perpendicular to the axis of rotation of the polygonal mirror, and wherein one emitter of each emitter pair is above and the other emitter of each emitter pair is below the plane that is perpendicular to the axis of rotation.

14. An apparatus according to claim 9 wherein the emitter/receiver channels each include a receiver, and wherein the receivers are arranged at the same location as the corresponding emitters.

15. An apparatus according to claim 9 wherein at least one emitter/receiver channel includes a partially reflecting mirror placed in a beam path between the emitter and the polygonal mirror and being tilted with respect to the light beams.

16. An apparatus according to claim 9 wherein the polygonal mirror has an odd number of reflecting surfaces.

17. An apparatus according to claim 9 wherein at least one of the emitter/receiver channels is focused by autocollimation.

18. An apparatus according to claim 9 wherein the emitter/receiver channels each include a receiver, and wherein at least one of the receivers comprises an omnidirectional receiver.

19. An apparatus according to claim 9 wherein the at least two emitter/receiver channels have different focal lengths.

20. An apparatus according to claim 9 wherein at least two emitter/receiver channels include different diaphragms for shaping a focal spot.

21. An apparatus according to claim 9 wherein at least two emitter/receiver channels include different light polarizers.

22. An apparatus according to claim 9 wherein the emitters of at least two emitter/receiver channels have different modulation frequencies, and wherein receivers of the at least two emitter/receiver channels are tuned to the different modulation frequencies.

23. An apparatus according to claim 9 wherein at least two emitters emit light of different wavelengths, and wherein receivers are tuned to the different modulation frequencies.

24. An apparatus according to claim 9 wherein at least two emitters have an astigmatism, and wherein the at least two emitters are rotationally offset relative to each other in dependence on the radiating characteristics of the emitters.

25. An apparatus according to claim 9 wherein at least two emitter/receiver channels employ different signal encoding or conditioning.

26. An apparatus according to claim 9 wherein at least two emitter/receiver channels employ different code recognition techniques.
